(19) United States
(12) Patent Application Publication
(10) Pub. No.: US 2009/0095926 A1
(43) Pub. Date: Apr. 16, 2009

(54) PHYSIOLOGICAL PARAMETER DETECTOR

(76) Inventor: William Jack MacNeish, III, Costa Mesa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/248,855

(22) Filed: Oct. 9, 2008

Related U.S. Application Data
(60) Provisional application No. 60/979,658, filed on Oct. 12, 2007.

(51) Int. Cl. H01J 5/18

(52) U.S. Cl. 250/505.1

(57) ABSTRACT

A pulse oximetry sensor has an emitter adapted to transmit optical radiation into a tissue site and a ceramic detector adapted to receive optical radiation from the emitter after tissue site absorption. The detector is surrounded by shielding material to reduce undesirable electromagnetic interference.

### REFERENCE TO RELATED APPLICATION

The present application claims priority benefit under 35 U.S.C. §119 (e) from U.S. Provisional Application No. 60/979,658, filed Oct. 12, 2007, entitled “Ceramic Detector,” which is incorporated herein by reference. RELATED CASES

The present disclosure is generally related to U.S. Provisional Patent Application Ser. No. 60/288,324, filed May 3, 2001; U.S. Provisional Patent Application Ser. No. 60/301,183, filed Jun. 27, 2001; U.S. patent application Ser. No. 10/137,942, filed May 2, 2002, now U.S. Pat. No. 6,985,764; U.S. patent application Ser. No. 11/293,583, filed Dec. 2, 2005; U.S. Provisional Patent Application No. 60/876,758, filed Dec. 22, 2006; and U.S. patent application Ser. No. 09/003,224, filed Jan. 6, 1998, now U.S. Pat. No. 6,184,521; and incorporates each of the foregoing herein by reference.

### FIELD OF THE DISCLOSURE

The disclosure relates to the field of physiological sensors, and more specifically to detectors for physiological sensors.

### BACKGROUND OF THE DISCLOSURE

Pulse oximetry provides a noninvasive procedure for measuring the oxygen status of circulating blood and has gained rapid acceptance in a wide variety of medical applications, including surgical wards, intensive care and neonatal units, general wards, and home care and physical training. A pulse oximetry system generally includes a physiological sensor applied to a patient, a monitor, and a patient cable connecting the sensor and the monitor. The sensor has light emitters and a detector, which are attached to a tissue site, such as a finger. The patient cable transmits emitter drive signals from the monitor to the sensor where the emitters respond to the drive signals to transmit light into the tissue site. The detector is responsive to the emitted light after attenuation by pulsatile blood flowing in the tissue site. The detector outputs a detector signal to the monitor. The monitor processes the detector signal to provide a numerical readout of physiological parameters such as oxygen saturation (SpO2) and pulse rate. Enhanced oximetry systems can also include multiple parameter monitor and a multiple wavelength sensor that provides enhanced measurement capabilities, including for example, the measurement of a multitude of blood constituents and related parameters in addition to oxygen saturation and pulse rate, such as, for example, carboxyhemoglobin (HbCO), methemoglobin (HbMet), total Hematocrit (Hbt), oxygen concentrations, glucose concentrations or the like.

Physiological monitoring systems are often operated in electromagnetically noisy environments such as hospitals. In these environments it is particularly advantageous for physiological monitoring sensors to reject electromagnetic noise and to preserve the fidelity of the measured signal. Furthermore, improved electromagnetic immunity can allow for increased accuracy or additional functionality even in environments with relatively low electromagnetic noise.

### SUMMARY OF THE DISCLOSURE

Aspects of the present disclosure include a detector providing protection against electromagnetic interference for an included sensor. In an embodiment, the detector includes a sensor, a carrier, and a shield. The shield and carrier are coupled to act as a Faraday cage, improving the electromagnetic noise immunity of the sensor.

In an embodiment, the carrier can be formed using a ceramic material. The carrier can include a cavity for placement of a sensor. The carrier and sensor are at least partially covered by shielding material in order to increase electromagnetic noise immunity of the sensor.

In an embodiment, shielding material can be printed directly on the sensor. The shielding material can partially cover one side or multiple sides of the sensor. The shielding material can be electrically coupled to ground or left floating to increase electromagnetic noise immunity of the sensor.

Aspects of the present disclosure also include methods for assembling detectors that provide protection against electromagnetic interference. The method includes the step of coupling sensors to carriers. In an embodiment, the method also includes coupling shields to the carriers. In an embodiment, instead of or in addition to a coupled shield, the shield is printed directly on the sensor. The shields, or shields and carriers, improve the electromagnetic noise immunity of the resulting detector.

Aspects of the present disclosure also include methods for manufacturing detectors to reduce costs. In an embodiment, the manufacturer forms a plurality of attached carriers, sensors, and shields. The sensors, shields, and carriers are then coupled together to form a plurality of attached detectors. Once assembled, the detectors can then be separated such as by cutting or breaking apart along perforated lines to form individual detectors. This provides a method of manufacturing detectors with reduced effort and reduced cost.

### BRIEF DESCRIPTION OF THE DRAWINGS

FIG. 1 illustrates an embodiment of a physiological measurement system.

FIGS. 2A-C illustrate several embodiments of sensor assemblies.

FIG. 3 illustrates a block diagram of an embodiment of an oximetry system.

FIG. 4 illustrates a block diagram of an embodiment of the ceramic detector.

FIGS. 5A-B illustrate perspective and top views, respectively, of an embodiment of the ceramic detector with a die bond.

FIGS. 6A-B illustrate perspective and top views, respectively, of an embodiment of the ceramic detector with a wire bond.

FIGS. 7A-C illustrate perspective, top, and side views, respectively, of an embodiment of the ceramic detector with an encapsulate fill.

FIGS. 8A-D illustrate perspective top, perspective bottom, top and side views, respectively, of embodiments of the ceramic detector with the top shield in place.

FIGS. 9A-F illustrate cross sectional views of several embodiments of the ceramic detectors.

FIG. 10 illustrates a block diagram of an embodiment of the ceramic detectors.

FIGS. 11A-B illustrate top and perspective views of an embodiment of the ceramic detector with a printed mesh.

FIG. 11C illustrates a top view of an embodiment of the ceramic detector with printed slats.

FIG. 11D illustrates a cross sectional view of an embodiment of the ceramic detector with a printed shield and a carrier.

FIG. 12A illustrates the assembly process of an embodiment of the ceramic detector.

FIG. 12B illustrates an embodiment of a group of ceramic carriers, sensors, and shields as manufactured.

FIG. 12C illustrates an embodiment of a group of ceramic detectors as manufactured.

FIGS. 13 illustrates a flow chart of a manufacturing process for an embodiment of the ceramic detector.

FIGS. 14 illustrates a flow chart of a manufacturing process for an embodiment of the ceramic detector.

FIGS. 15A-B illustrate flow charts of manufacturing processes for embodiments of the ceramic detector.

FIG. 16 illustrates an embodiment of the ceramic detector with a physiological sensor interface.

### DETAILED DESCRIPTION

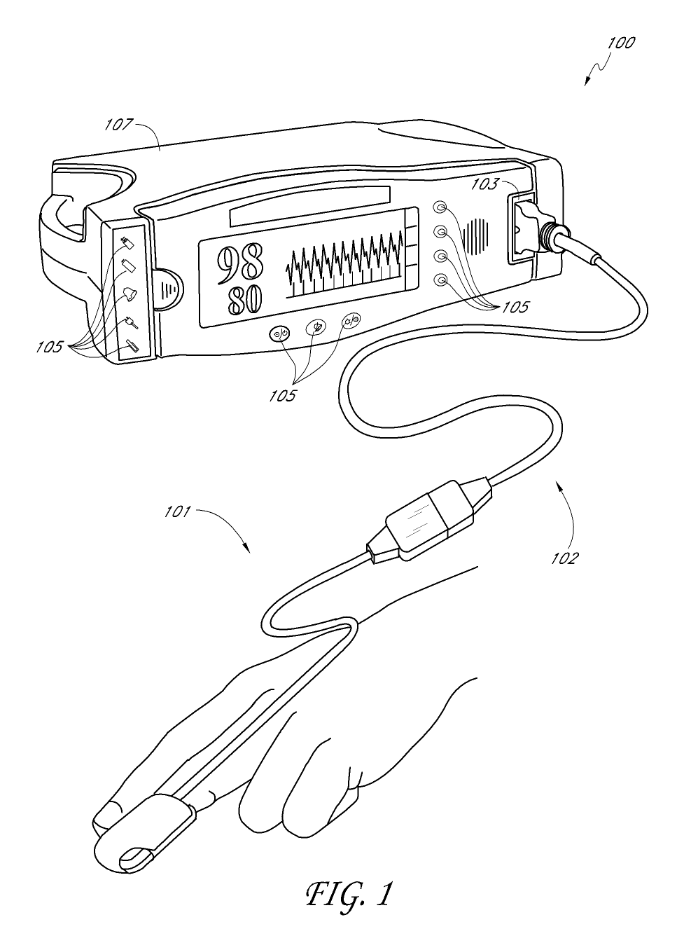

FIG. 1 illustrates an embodiment of a physiological measurement system 100 having a monitor 107 and a sensor assembly 101. The physiological measurement system 100 allows the monitoring of a person, including a patient. In particular, the multiple wavelength sensor assembly 101 allows the measurement of blood constituents and related parameters, including, for example, oxygen saturation, HbCO, HBMet and pulse rate, among others.

In an embodiment, the sensor assembly 101 is configured to plug into a monitor sensor port 103. Monitor keys 105 provide control over operating modes and alarms, to name a few. A display 107 provides readouts of measured parameters, such as oxygen saturation, pulse rate, HbCO and HbMet to name a few.

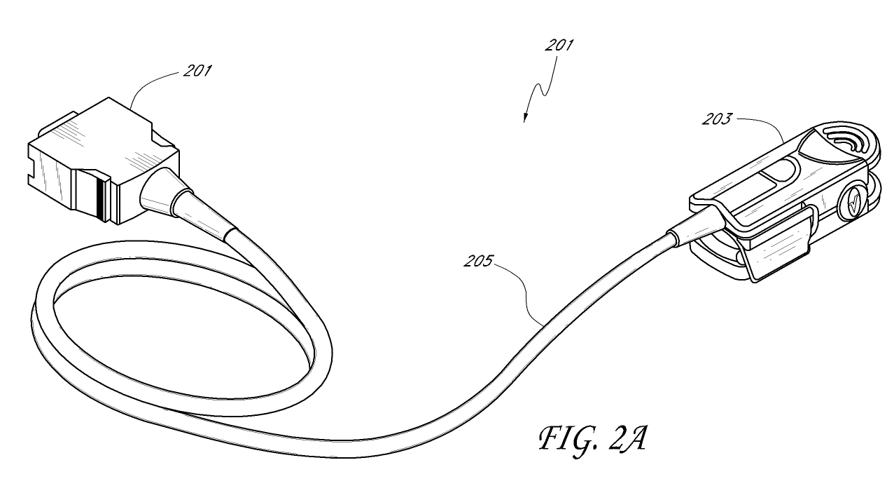

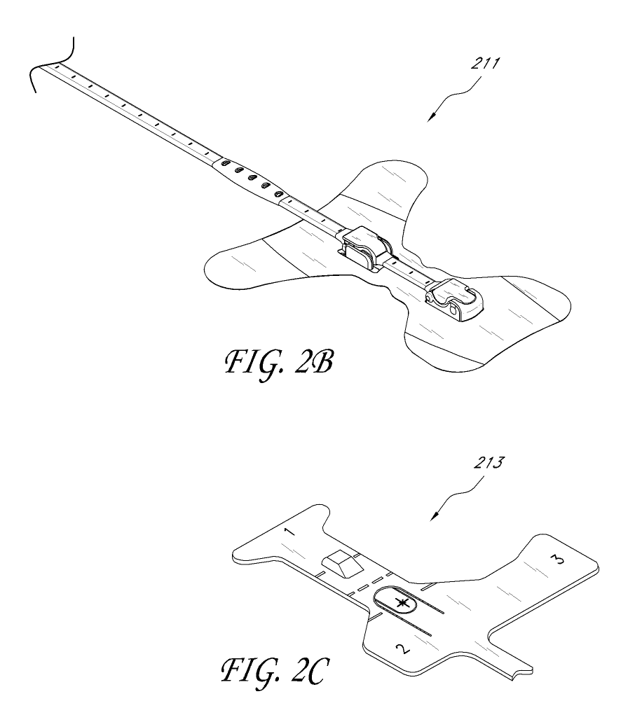

FIG. 2A illustrates a multiple wavelength sensor assembly 201 having a sensor 203 adapted to attach to a tissue site, a sensor cable 205 and a monitor connector 201. In an embodiment, the sensor 203 is incorporated into a reusable finger clip adapted to removably attach to, and transmit light through, a fingertip. The sensor cable 205 and monitor connector 201 are integral to the sensor 203, as shown. In embodiments, the sensor 203 can be configured separately from the cable 205 and connector 201, although such communication can advantageously be wireless, over public or private networks or computing systems or devices, through intermediate medical or other devices, combinations of the same, or the like.

FIGS. 2B-C illustrate alternative sensor embodiments, including a sensor 211 (FIG. 2B) partially disposable and partially reusable (resposable) and utilizing an adhesive attachment mechanism. Also shown is a sensor 213 being disposable and utilizing an adhesive attachment mechanism. In other embodiments, a sensor can be configured to attach to various tissue sites other than a finger, such as a foot or an ear. Also a sensor can be configured as a reflectance or transflectance device that attaches to a forehead or other tissue surface. The artisan will recognize from the disclosure herein that the sensor can include mechanical structures, adhesive or other tape structures, Velcro wraps or combination structures specialized for the type of patient, type of monitoring, type of monitor, or the like.

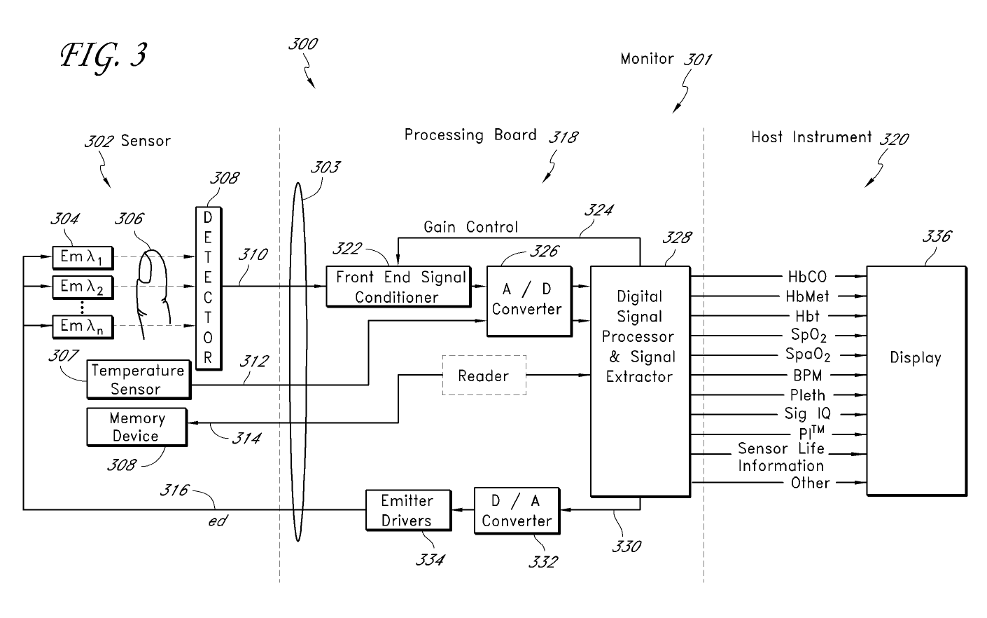

FIG. 3 illustrates a block diagram of an exemplary embodiment of a monitoring system 300. As shown in FIG. 3, the monitoring system 300 includes a monitor 301, a noninvasive sensor 302, communicating through a cable 303. In an embodiment, the sensor 302 includes a plurality of emitters 304 irradiating the body tissue 306 with light, and one or more detectors 308 capable of detecting the light after attenuation by tissue 306. As shown in FIG. 3, the sensor 302 also includes a temperature sensor 307, such as, for example, a thermistor or the like. The sensor 302 also includes a memory device 308 such as, for example, an EEPROM, EPROM or the like. The sensor 302 also includes a plurality of conductors communicating signals to and from its components, including detector composite signal conductors 310, temperature sensor conductors 312, memory device conductors 314, and emitter drive signal conductors 316.

According to an embodiment, the sensor conductors 310, 312, 314, 316 communicate their signals to the monitor 301 through the cable 303. Although disclosed with reference to the cable 303, a skilled artisan will recognize from the disclosure herein that the communication to and from the sensor 306 can advantageously include a wide variety of cables, cable designs, public or private communication networks or computing systems, wired or wireless communications (such as Bluetooth or WiFi, including IEEE 801.11a, b, or g), mobile communications, combinations of the same, or the like. In addition, communication can occur over a single wire or channel or multiple wires or channels.

In an embodiment, the temperature sensor 307 monitors the temperature of the sensor 302 and its components, such as, for, example, the emitters 304. For example, in an embodiment, the temperature sensor 307 includes or communicates with a thermal bulk mass having sufficient thermal conduction to generally approximate a real-time temperature of a substrate of the light emission devices 304. The foregoing approximation can advantageously account for the changes in surface temperature of components of the sensor 302, which can change as much or more than ten degrees Celsius (10° C.) when the sensor 302 is applied to the body tissue 306. In an embodiment, the monitor 101 can advantageously use the temperature sensor 307 output to, among other things, ensure patient safety, especially in applications with sensitive tissue. In an embodiment, the monitor 301 can advantageously use the temperature sensor 307 output and monitored operating current or voltages to correct for operating conditions of the sensor 302 as described in U.S. patent application Ser. No. 11/366209, filed Mar. 1, 2006, entitled “Multiple Wavelength Sensor Substrate,” and herein incorporated by reference.

The memory 308 can include any one or more of a wide variety of memory devices known to an artisan from the disclosure herein, including an EPROM, an EEPROM, a flash memory, a combination of the same or the like. The memory 308 can include a read-only device such as a ROM, a read and write device such as a RAM, combinations of the same, or the like. The remainder of the present disclosure will refer to such combination as simply EPROM for ease of disclosure; however, an artisan will recognize from the disclosure herein that the memory 308 can include the ROM, the RAM, single wire memories, combinations, or the like.

The memory device 308 can advantageously store some or all of a wide variety data and information, including, for example, information on the type or operation of the sensor 302, type of patient or body tissue 306, buyer or manufacturer information, sensor characteristics including the number of wavelengths capable of being emitted, emitter specifications, emitter drive requirements, demodulation data, calculation mode data, calibration data, software such as scripts, executable code, or the like, sensor electronic elements, sensor life data indicating whether some or all sensor components have expired and should be replaced, encryption information, monitor or algorithm upgrade instructions or data, or the like. In an embodiment, the memory device 308 can also include emitter wavelength correction data.

In an advantageous embodiment, the monitor reads the memory device on the sensor to determine one, some or all of a wide variety of data and information, including, for example, information on the type or operation of the sensor, a type of patient, type or identification of sensor buyer, sensor manufacturer information, sensor characteristics including the number of emitting devices, the number of emission wavelengths, data relating to emission centroids, data relating to a change in emission characteristics based on varying temperature, history of the sensor temperature, current, or voltage, emitter specifications, emitter drive requirements, demodulation data, calculation mode data, the parameters it is intended to measure (e.g., HbCO, HbMet, etc.) calibration data, software such as scripts, executable code, or the like, sensor electronic elements, whether it is a disposable, reusable, or multi-site partially reusable, partially disposable sensor, whether it is an adhesive or non-adhesive sensor, whether it is reflectance or transmittance sensor, whether it is a finger, hand, foot, forehead, or ear sensor, whether it is a stereo sensor or a two-headed sensor, sensor life data indicating whether some or all sensor components have expired and should be replaced, encryption information, keys, indexes to keys or has functions, or the like monitor or algorithm upgrade instructions or data, some or all of parameter equations, information about the patient, age, sex, medications, and other information that can be useful for the accuracy or alarm settings and sensitivities, trend history, alarm history, sensor life, or the like.

FIG. 3 also shows the monitor 301 comprising one or more processing boards 318 communicating with one or more host instruments 320. According to an embodiment, the board 318 includes processing circuitry arranged on one or more printed circuit boards capable of installation into the handheld or other monitor 301, or capable of being distributed as an OEM component for a wide variety of host instruments 320 monitoring a wide variety of patient information, or on a separate unit wirelessly communicating to it. As shown in FIG. 3, the board 318 includes a front end signal conditioner 322 including an input receiving the analog detector composite signal from the detector 308, and an input from a gain control signal 324. The signal conditioner 322 includes one or more outputs communicating with an analog-to-digital converter 326 (“A/D converter 326”).

The A/D converter 326 includes inputs communicating with the output of the front end signal conditioner 322 and the output of the temperature sensor 307. The converter 326 also includes outputs communicating with a digital signal processor and signal extractor 328. The processor 328 generally communicates with the A/D converter 326 and outputs the gain control signal 324 and an emitter driver current control signal 330. The processor 328 also communicates with the memory device 308. As shown in phantom, the processor 328 can use a memory reader, memory writer, or the like to communicate with the memory device 308. Moreover, FIG. 3 also shows that the processor 328 communicates with the host instrument 320 to for example, display the measured and calculated parameters or other data.

FIG. 3 also shows the board 318 including a digital-to-analog converter 332 (“D/A converter 332”) receiving the current control signal 330 from the processor 328 and supplying control information to emitter driving circuitry 334, which in turns drives the plurality of emitters 304 on the sensor 302 over conductors 316. In an embodiment, the emitter driving circuitry 334 drives sixteen (16) emitters capable of emitting light at sixteen (16) predefined wavelengths, although the circuitry 334 can drive any number of emitters. For example, the circuitry 334 can drive two (2) or more emitters capable of emitting light at two (2) or more wavelengths, or it can drive a matrix of eight (8) or more emitters capable of emitting light at eight (8) or more wavelengths. In addition, one or more emitters could emit light at the same or substantially the same wavelength to provide redundancy.

In an embodiment, the host instrument 320 communicates with the processor 328 to receive signals indicative of the physiological parameter information calculated by the processor 328. The host instrument 320 preferably includes one or more display devices 336 capable of providing indicia representative of the calculated physiological parameters of the tissue 306 at the measurement site. In an embodiment, the host instrument 320 can advantageously includes virtually any housing, including a handheld or otherwise portable monitor capable of displaying one or more of the foregoing measured or calculated parameters. In still additional embodiments, the host instrument 320 is capable of displaying trending data for one or more of the measured or determined parameters. Moreover, an artisan will recognize from the disclosure herein many display options for the data available from the processor 328.

In an embodiment, the host instrument 320 includes audio or visual alarms that alert caregivers that one or more physiological parameters are falling below or above predetermined safe thresholds, which are trending in a predetermined direction (good or bad), and can include indications of the confidence a caregiver should have in the displayed data. In further embodiment, the host instrument 320 can advantageously include circuitry capable of determining the expiration or overuse of components of the sensor 302, including, for example, reusable elements, disposable elements, or combinations of the same. Moreover, a detector could advantageously determine a degree of clarity, cloudiness, transparence, or translucence over an optical component, such as the detector 308, to provide an indication of an amount of use of the sensor components and/or an indication of the quality of the photo diode.

An artisan will recognize from the disclosure herein that the emitters 304 and/or the detector 308 can advantageously be located inside of the monitor, or inside a sensor housing. In such embodiments, fiber optics can transmit emitted light to and from the tissue site. An interface of the fiber optic, as opposed to the detector can be positioned proximate the tissue. In an embodiment, the physiological monitor accurately monitors HbCO in clinically useful ranges. This monitoring can be achieved with non-fiber optic sensors. In another embodiment, the physiological monitor utilizes a plurality, or at least four, non-coherent light sources to measure one or more of the foregoing physiological parameters. Similarly, non-fiber optic sensors can be used. In some cases the monitor receives optical signals from a fiber optic detector. Fiber optic detectors are useful when, for example, monitoring patients receiving MRI or cobalt radiation treatments, or the like. Similarly, light emitters can provide light from the monitor to a tissue site with a fiber optic conduit. Fiber optics are particularly useful when monitoring HbCO and HbMet. In another embodiment, the emitter is a laser diode place proximate tissue. In such cases, fiber optics are not used. Such laser diodes can be utilized with or without temperature compensation to affect wavelength.

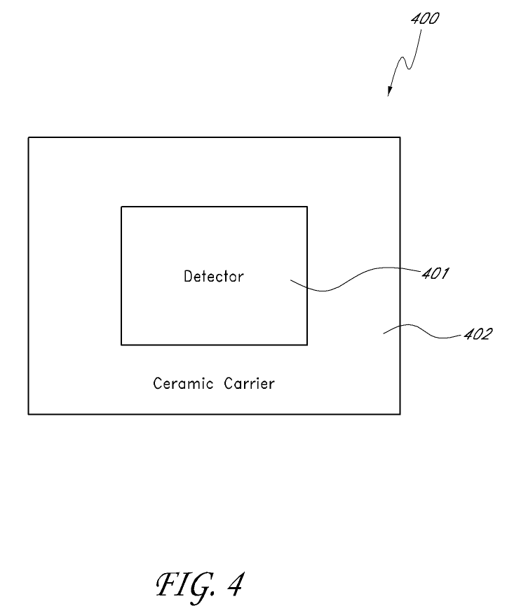

FIG. 4 illustrates an embodiment of a detector 400 including a sensor 401 and a carrier 402. The carrier 402 acts as a mechanical support for and provides electrical contacts to the sensor 401. In an embodiment, the carrier acts as an electrical insulator allowing the sensor 401 to be electrically isolated from shielding applied to the detector 400. In an embodiment, the carrier 402 can be formed out of ceramic material. The carrier 402 can be formed by processes such as, for example, molding, injecting, rolling, pressing, casting, extruding, or other processes as would be understood by those of skill in the art from the present disclosure. The carrier can be made from high temperature ceramics, such as, for example, alumina ceramic.

FIG. 5A illustrates a perspective view of an embodiment of a ceramic detector 500. In this embodiment, parts of the sensor 501 are electrically isolated from shielding material 503 by the carrier 502. Shielding material 503 can be incorporated in carrier 502, for example, during manufacture. Alternatively, the shielding material 503 can be attached to the carrier 502 after manufacture. This can be accomplished by attachment methods such as, for example, painting, attaching, gluing, adhering, etching, fusing, mechanically fastening, or other attachment methods as would be understood by those of skill in the art from the present disclosure. The shielding material 503 can be made from tungsten, copper, silver-filled thermoplastic, nickel, gold, copper, or any other conductive materials, or other suitable material as would be understood by those of skill in the art from the present disclosure.

FIG. 5B illustrates a top view of the embodiment of the ceramic detector in FIG. 5A. Sensor 501 can be die bonded or electrically coupled in any way to an electrical output 506 as described below. The electrical output 506 can be repositioned or omitted from the carrier 502.

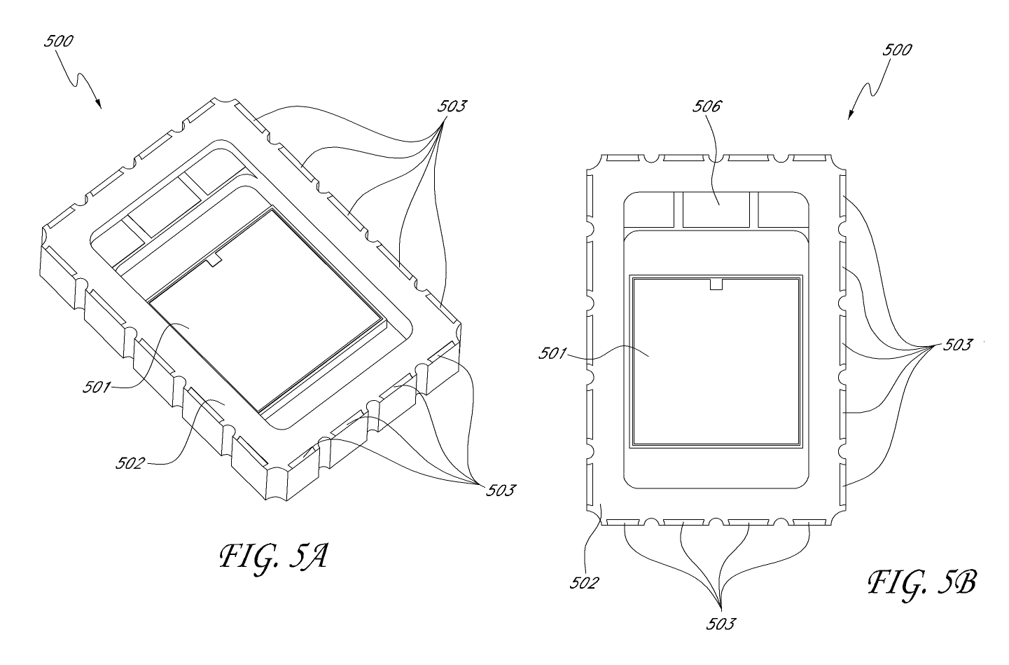

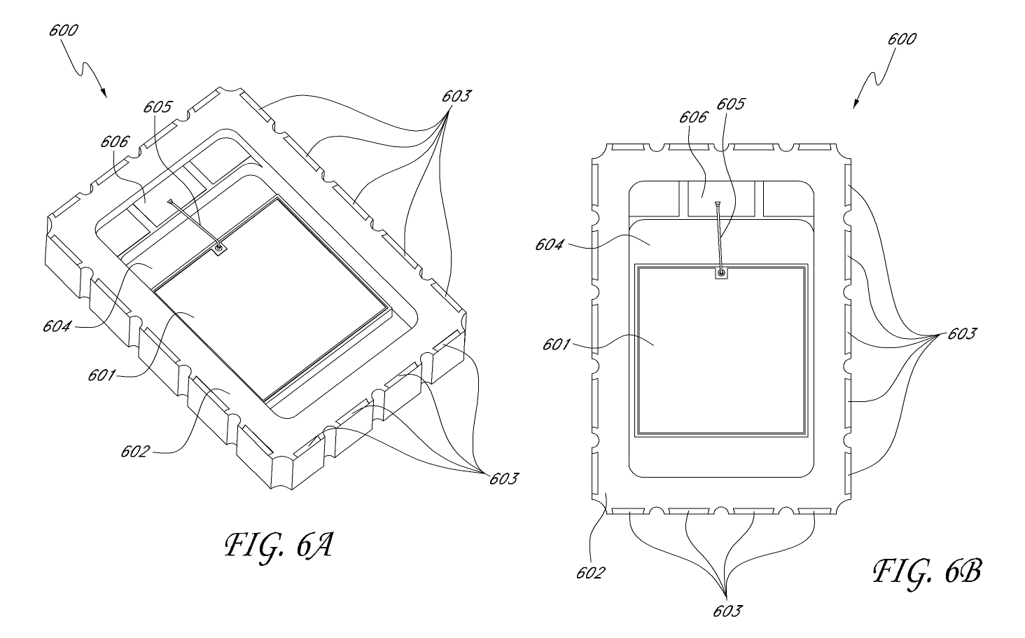

FIGS. 6A and 6B illustrate a perspective view and a top view, respectively, of an embodiment of a ceramic detector 600 including a sensor 601, a carrier 602, and shielding material 603. Connector 605 allows for the electrical connection of sensor 601 to an electrical output 606. In an embodiment, the sensor 601 is wire bonded through connector 605 to the electrical output 606 as shown in FIGS. 6A and 6B. Shielding material 603 can be attached or incorporated into the carrier 602 as disclosed above.

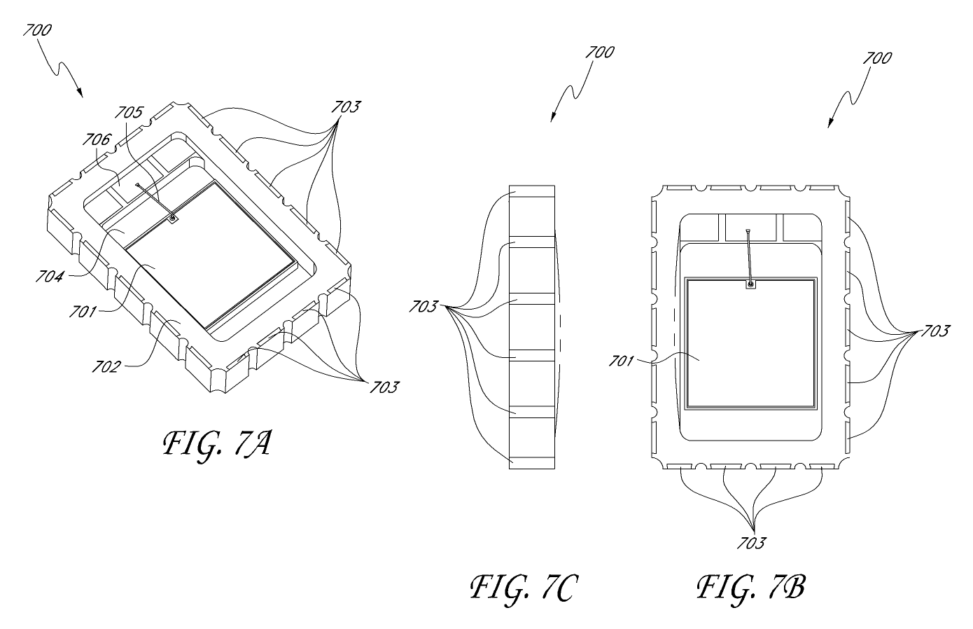

FIG. 7A-C illustrate a perspective view, a top view, and a side view, respectively, of an embodiment the ceramic detector 700. The sensor 701 is electrically isolated by the carrier 702. Connector 705 allows for the electrical connection of sensor 701 and electrical output 706. The connector 705 can be realized through processes such as wire bonding or die bonding or other types of connections as would be understood by those of skill in the art from the present disclosure. In an embodiment, carrier 702 is filled with an encapsulate 704. The encapsulate 704 can be transparent or translucent. The encapsulate 704 serves a protective function for the sensor 701. The carrier 702 also allows for shielding material 703 to be attached or incorporated into the carrier as described above. The encapsulate 704 can also serve as a printing surface or attachment location for additional shielding material, completing a Faraday cage formed with shielding material 703.

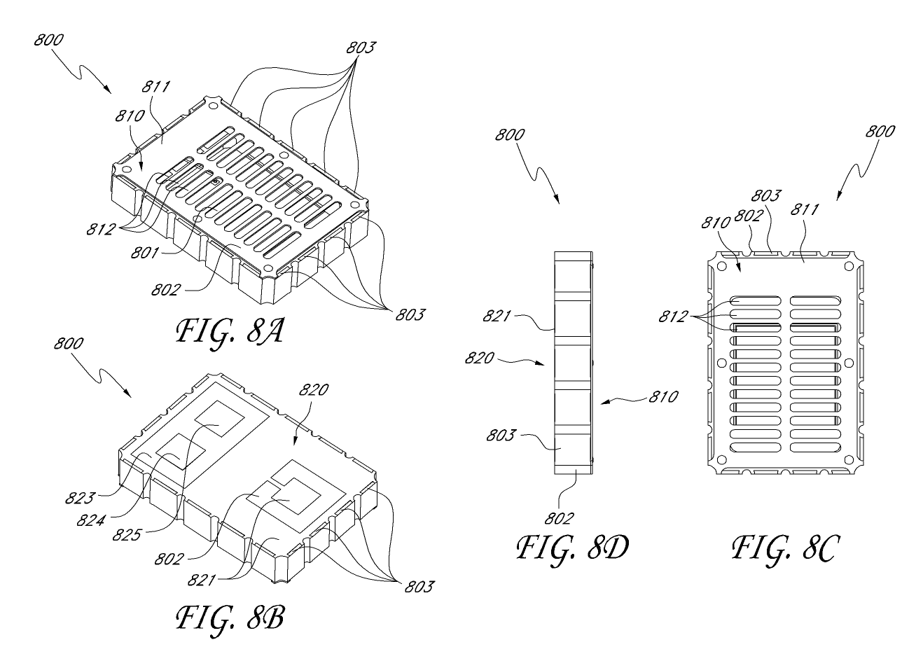

FIG. 8A illustrates a perspective view of an embodiment of a ceramic detector 800. The sensor 801 is electrically isolated by the carrier 802. The carrier 802 also allows for shielding material 803 to be attached. The shielding material 803 alternatively can be printed on the carrier using tungsten copper or other suitable ink. Shielding material 803 can also be incorporated in carrier 802 in a carrier forming process. In an embodiment, the top cover 810 includes a shielding surface 811 and windows 812. Windows 812 can be any shape appropriate to allow the passage of light but block electromagnetic noise, such as, for example, lines, circles, rectangles, ellipses, ovals, triangles, diamonds, other polygons, or other shapes as would be understood by those of skill in the art from the present disclosure. The shielding surface 811 can be electrically and/or mechanically coupled to the shielding material 803 allowing the top cover 810 to form one side of a completed Faraday cage. Mechanical coupling can be, for example, gluing, welding, soldering, screwing, snap fitting, or other suitable fastening. Electrical coupling can be, for example, soldering, wire bonding, die bonding, or other suitable forms of electrical connection.

FIG. 8B illustrates a bottom perspective view of the embodiment of FIG. 8A including a bottom side 820 of carrier 802. In an embodiment, the bottom surface 821 electrically couples to the shielding material 803. The bottom surface 821 can be printed, for example, with shielding material to complete part of a Faraday cage. Additional shielding material can be attached to or plated on bottom surface 821. Electrical connection pads 823 and 824 serve as electrical interface points for the detector 800.

FIG. 8C illustrates a top view of the embodiment of FIGS. 8A and 8B. FIG. 8D illustrates a side view of the embodiment of FIGS. 8A and 8B. In an embodiment, the top cover 810 is electrically coupled to the carrier 802. In an embodiment, the top cover 810 is electrically coupled to the carrier 802 and both are electrically coupled to ground.

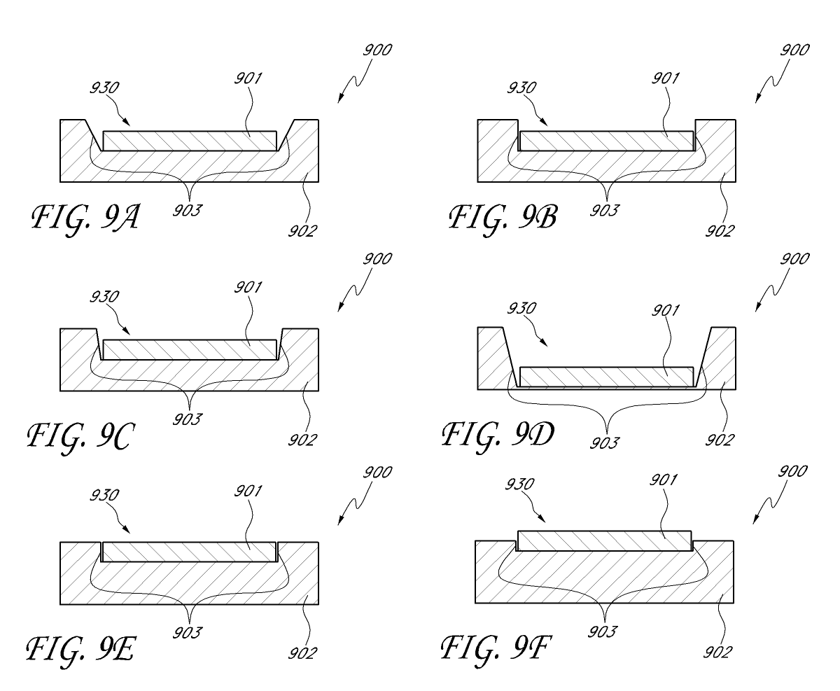

FIG. 9A illustrates a cross sectional view of an embodiment of the ceramic detector 900 including a sensor 901 and a carrier 902. The carrier 902 has a cavity 930 that is formed with cavity sides 903. The cavity sides 903 can be advantageously formed to permit or restrict light to reach the sensor 901. The cavity sides 903 can be vertical, round, diagonally cut, or formed in other shapes advantageous to either permit or restrict light to reach the sensor 901, to enhance properties of the carrier 902 including, but not limited to, structural and manufacturing concerns, to assist in the interface of the sensor 901 with the carrier 902, or to enhance the performance of the ceramic detector 900.

FIG. 9B illustrates a cross sectional view of an embodiment of the ceramic detector 900 including a sensor 901 and a carrier 902. The cavity sides 903 can mechanically couple with the sensor 901. FIG. 9B also illustrates the use of cavity sides 903 to restrict undesired light from reaching the sensor 903. In an embodiment, the cavity 930 can be filled with an encapsulate as described above. The encapsulate can serve a protective function for the sensor 901 or as a means for mechanically coupling the sensor 901 to the carrier 902. The encapsulate can also interface with the cavity sides 903.

FIGS. 9C-D illustrate cross sectional views of embodiments of the ceramic detector 900 including a sensor 901 and a carrier 902. The cavity 930 can be formed in different shapes, discussed previously. The cavity 930 can also be formed in different depths and the ratio of depth to the height of the carrier 902, as illustrated by FIGS. 9C and 9D.

FIG. 9E illustrates a cross sectional view of an embodiment of the ceramic detector 900 including a sensor 901 and a carrier 902. The size of the cavity 930 can be equal to the size of the sensor 901.

FIG. 9F illustrates a cross sectional view of an embodiment of the ceramic detector 900 including a sensor 901 and a carrier 902. The size of the cavity 930 can be less than the size of the sensor 901. In this embodiment, the sensor 901 protrudes above the carrier 902.

Of course, the foregoing embodiments are given by way of example and not limitation. Other variations of carrier formation will be understood by those of skill in the art from the present disclosure. For example, cavity 930 can be different shapes, sizes, or have different relative positions to the carrier 902. Cavity sides 903 can be straight (FIG. 9B) on some sides and a different shapes such as diagonal (FIG. 9D) on other sides. The relative height of the sensor 901 or cavity 930 can change. These combinations do not provide an extensive list of possible substitutions or modifications that will be apparent to the skilled artisan in view of the disclosure herein.

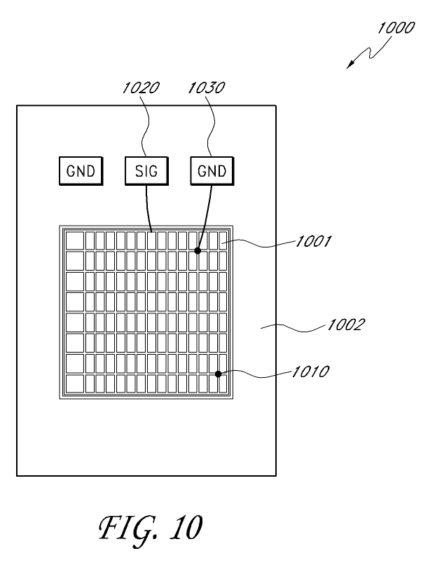

FIG. 10 schematically represents an embodiment of the ceramic detector 1000 including a sensor 1001, a shield 1010, a carrier 1002, and electrical interfaces, signal 1020 and ground 1030. The shield 1010 is electrically coupled to ground 1030. Alternatively, ground 1030 can be a floating ground. The electrical output of the sensor 1001 can be electrically coupled to signal 1020. The carrier 1002 serves as a physical interface for the ceramic detector 1000.

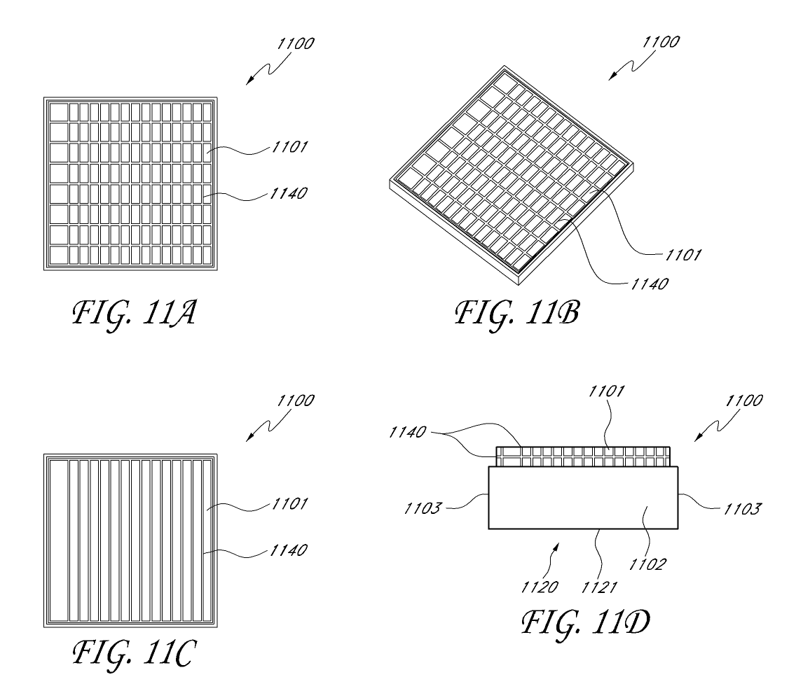

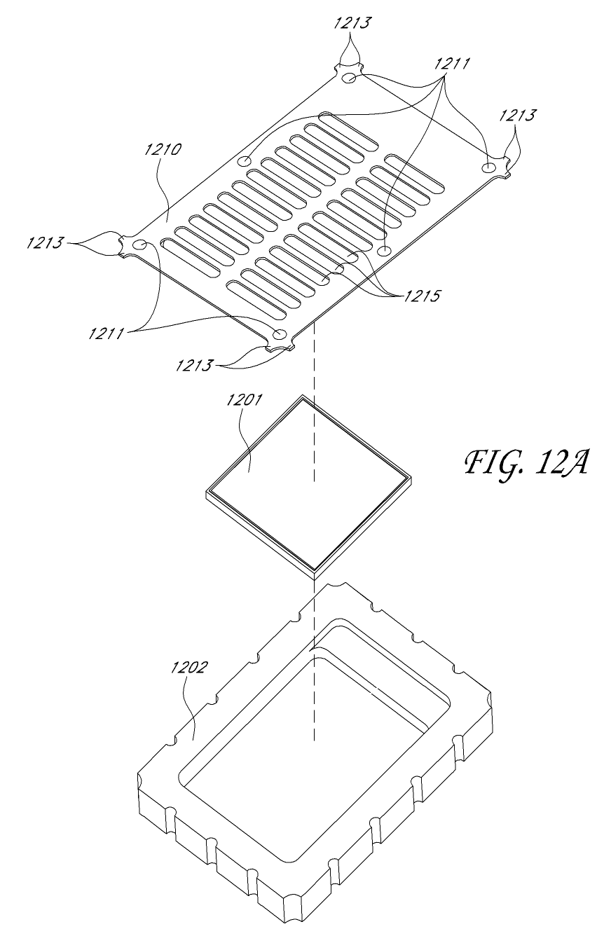

FIGS. 11A-B illustrate a top view and a perspective view, respectively, of an embodiment of the ceramic detector 1100 including a sensor 1101 and a mesh shield 1140. The mesh shield 1140 can be included on the sensor 1101 by chemical vapor deposition, printing, or other methods as would be understood by those of skill in the art from the present dislcosure. In an embodiment of the ceramic detector 1000, the mesh shield 1040 can also be placed on the sides and bottom of the sensor 1001.

FIG. 11C illustrates a top view an embodiment of the ceramic detector 1100 including a slated shield 1140. The shield 1140 can be formed with other shapes including, but not limited to, lines, rectangles, circles, ellipses, ovals, triangles, diamonds, other polygons, or other shapes as would be understood by those of skill in the art from the present disclosure.

FIG. 11D illustrates a side view of an embodiment of the ceramic detector 1100 including a sensor 1101, a mesh shield 1140, a carrier 1102, and a bottom surface 1121. The carrier 1102 allows for shielding material 1103 to be attached or incorporated as described above. The mesh shield 1140 can also be placed on the sides of the sensor 1101. The mesh shield 1140 can be electrically coupled to the shielding material 1103 and to the bottom surface 1121 or connected directly to ground.

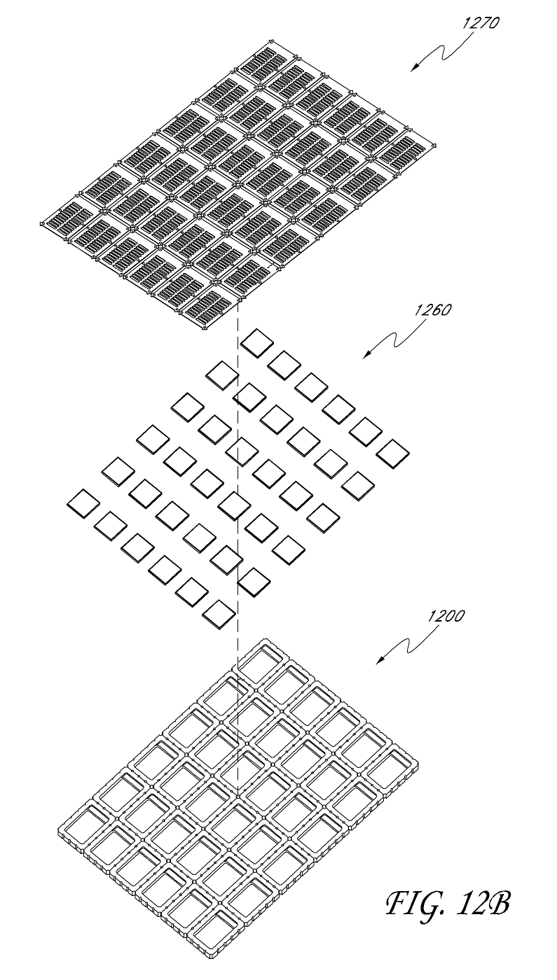

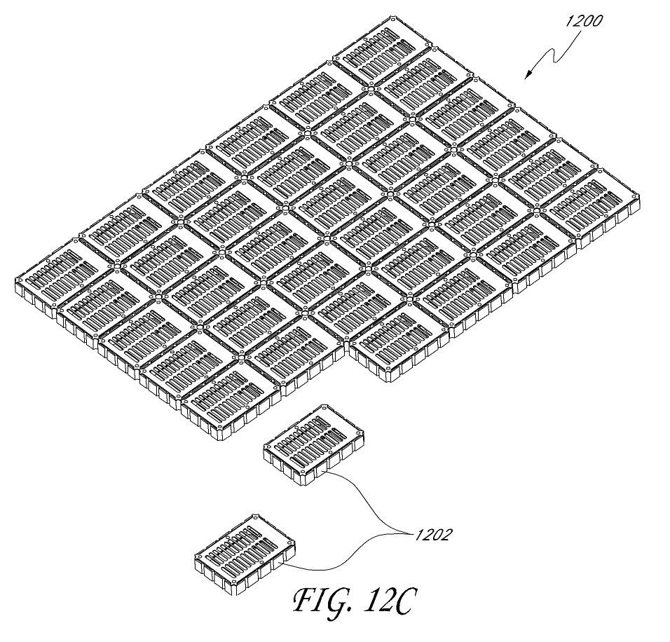

FIG. 12A illustrates an assembly process of an embodiment of the ceramic detector. The sensor 1201 can be electrically and/or mechanically coupled with the carrier 1202. The top cover 1210 can also be electrically and/or mechanically coupled with the carrier 1202. When assembled, the carrier 1202 and top cover 1210 form a Faraday cage around the sensor 1201, thereby increasing the ceramic detector's ability to block electromagnetic noise. The top cover 1210 includes tabs 1213, points 1211, and windows 1215 as described above. The tabs 1213 allow for the fabrication of a plurality of top covers 1210 as shown in FIG. 12B. The tabs also 1210 also allow for ease in the separation of top covers 1210 from a fabricated plurality. The points 1211 allow for increased ease in coupling the top cover 1210 to the carrier 1202. The points 1211 can also serve, for example, as machining points, snap fit coupling points, mechanical or chemical fastening points, or other manufacturing aids as would be understood by those of skill in the art from the present disclosure. The tabs 1211 and/or points 1213 can also serve as electrical or mechanical coupling interfaces for the top cover 1210 and carrier 1202.

FIG. 12B illustrates a group of carriers 1270, sensors 1260, and shields 1270. Those skilled in the art will recognize from the disclosure that other detector components such as those previously disclosed, or entire detector assemblies can be manufactured together to reduce cost or increase efficiency as shown in FIG. 12B. Manufacturing components in groups reduces costs, for example, by reducing the number of assembly steps. In an embodiment, a group of shields 1270 is stamped from a single sheet of shielding material and later separated into individual components.

FIG. 12C illustrates an embodiment of a group of detectors 1200 manufactured together in batches to reduce cost or increase efficiency as described above. A group of detectors 1200 can be designed for batch assembly, for example, with cutouts that allow for ease in separation of individual detectors 1202 such as by mechanically snapping the detectors apart or by otherwise applying separating force. Those skilled in the art will recognize from the disclosure that in addition to cutouts, for example, the group of detectors can be scored, cut, grooved, or otherwise prepared for separation to aid in manufacturing a group of detectors 1200.

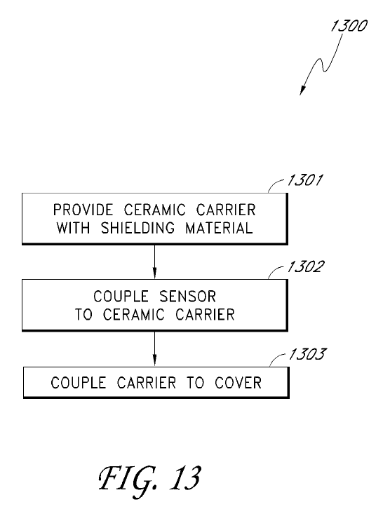

FIG. 13 illustrates a flow chart of a process 1300 for assembling a ceramic detector. The process 1300 begins with step 1301, where a ceramic carrier is provided. The carrier can include shielding material as described above. In step 1302, the sensor is coupled to the carrier. Alternatively, the sensor can be grown or manufactured directly on the carrier. A cover is then coupled to the ceramic carrier in step 1303. The cover can be coupled to the carrier as described above. This process 1300 could be done in groups, such as shown in FIGS. 12B-C.

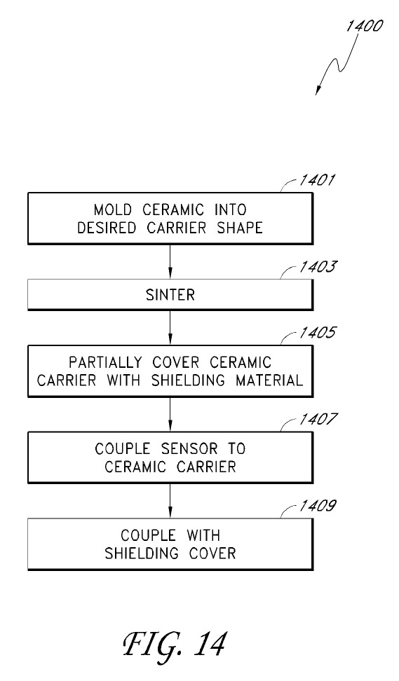

FIG. 14 illustrates a flow chart of a process for manufacturing a ceramic detector. The process 1400 begins with step 1401, where the manufacturer molds ceramic into the desired carrier shape. Molding, or forming, can begin with dry powder formed into a suitable shape. Once the shape is formed, the manufacturer can sinter the ceramic, step 1403, forming a coherent mass. The manufacturer then at least partially covers the carrier with shielding material at step 1405, either during or after the carrier forming process. The manufacturer then couples the sensor with the carrier, step 1407. Alternatively, the sensor can be grown or manufactured directly on the carrier. Finally, the manufacturer couples a shielding cover to the ceramic carrier in step 1409. Coupling can be completed as described above.

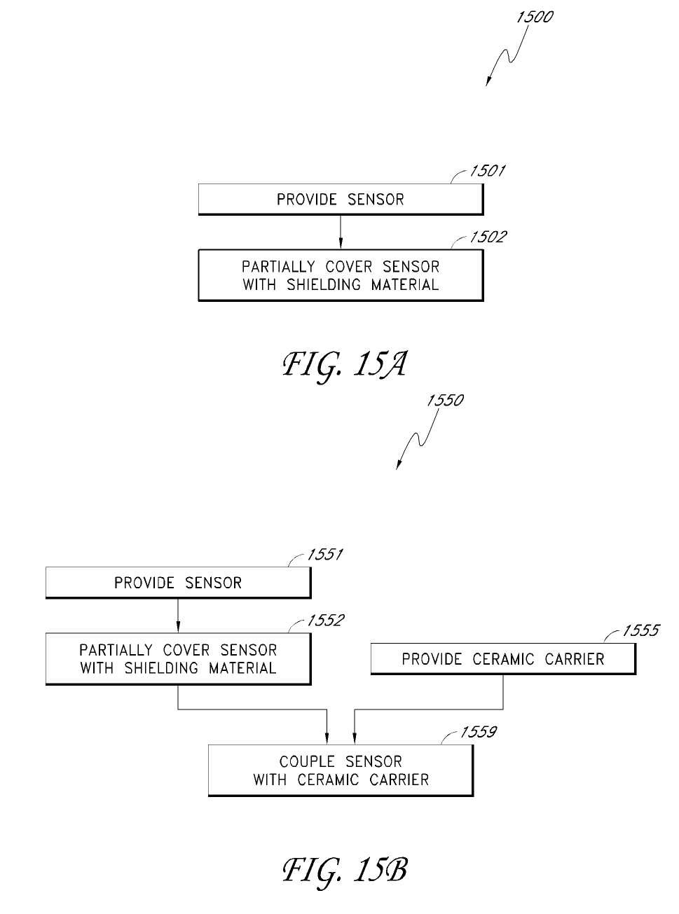

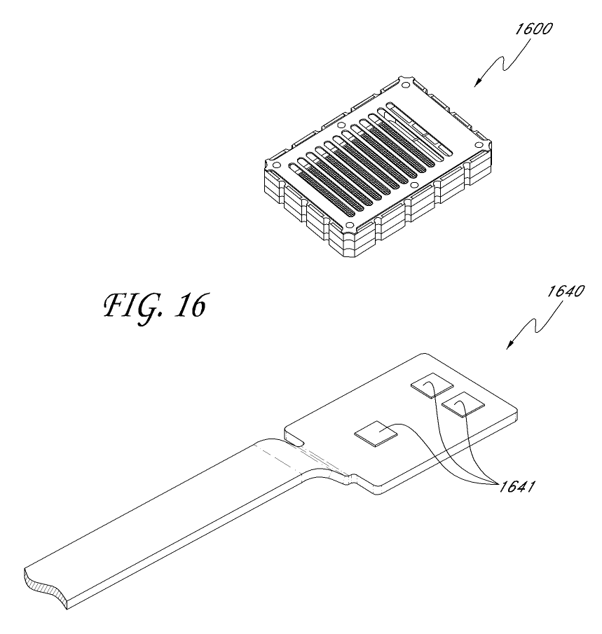

In an embodiment, a sensor can serve as the surface for application of shielding material. FIG. 15A illustrates a flow chart of a process 1500 for manufacturing a ceramic detector of this embodiment. The manufacturer provides the sensor at step 1501, and then at least partially covers the sensor with shielding material at step 1502. The covering can be done, for example, by chemical vapor deposition or other appropriate techniques. More than one side of the sensor can be covered with the shielding material, as described above. In an embodiment, all sides of the sensor can be covered. In an embodiment in which all sides are covered, a separate ceramic carrier can be omitted.

In an embodiment, a sensor with shielding material, as described above, can also be coupled with a ceramic carrier. FIG. 15B illustrates a flow chart of a process 1550 for manufacturing a ceramic detector of this embodiment. The sensor is provided at step 1551, and partially covered with shielding material at step 1552. The ceramic carrier is provided in step 1555. The sensor is coupled to the ceramic carrier in step 1559. Coupling can be completed as described above.

FIG. 16 illustrates an embodiment of the ceramic detector 1600 with a physiological sensor interface 1640. The sensor interface 1640 includes interface points 1641. The ceramic detector 1600 interfaces the interface points 1640 through connections such as, for example, soldering, fusing, or other connections as would be understood by those of skill in the art from the present disclosure. In an embodiment, solder paste is applied to interface points 1641, the ceramic detector 1600 is positioned on the physiological sensor interface 1640, and the paste is heated to solder the ceramic detector 1600 to the interface points 1641.

Although the foregoing disclosure has been described in terms of certain preferred embodiments, other embodiments will be apparent to those of ordinary skill in the art from the disclosure herein. For example, although disclosed with respect to a pulse oximetry sensor, the ideas disclosed herein can be applied to other sensors such as ECG/EKG sensor, blood pressure sensors, or any other physiological sensors. Additionally, the disclosure is equally applicable to physiological monitor attachments other than a sensor, such as, for example, a cable connecting the sensor to the physiological monitor. Additionally, other combinations, omissions, substitutions and modifications will be apparent to the skilled artisan in view of the disclosure herein. It is contemplated that various aspects and features of the disclosure described can be practiced separately, combined together, or substituted for one another, and that a variety of combination and subcombinations of the features and aspects can be made and still fall within the scope of the disclosure. Furthermore, the systems described above need not include all of the modules and functions described in the preferred embodiments. Accordingly, the present disclosure is not intended to be limited by the recitation of the preferred embodiments, but is to be defined by reference to the appended claims.

What is claimed is:

1. A physiological sensor configured to be used in a patient monitoring system, the sensor further configured to detect an indication of a physiological condition of a patient and output a signal indicative of the physiological condition to a patient monitoring system, the physiological sensor comprising:
at least one light emitting element configured to transmit light of a plurality of wavelengths; and
at least one detector configured to detect light attenuated by tissue of a patient, the detector comprising:
a sensor;
a ceramic carrier including shielding material at least partially surrounding the carrier and connected to ground to provide protection against undesired electromagnetic radiation; and
a top shielding layer including windows which allow the light attenuated by tissue of a patient to pass through while providing protection against undesired electromagnetic radiation.

2. The physiological sensor of claim 1, wherein the top shielding layer is electrically coupled to the shielding material of the ceramic carrier.

3. An optical detector for a physiological monitoring system comprising:
a photosensor having a first side and a second side;
a ceramic carrier configured to couple with the second side of the photosensor;
and
shielding material partially covering at least the first side of the photosensor, the shielding material configured to reduce the effects of electromagnetic radiation.

4. The detector of claim 3, wherein ceramic carrier comprises ceramic material and shielding material.

5. The detector of claim 3, wherein the shielding material is conductive ink.

6. A detector configured to detect desired signals and substantially reject undesired signals, the detector comprising:
a photosensor; and
a shielding mesh applied to said photosensor and configured to substantially reduce the detection of undesired signals and without substantially blocking the detection of desired signals.

7. The detector of claim 6, wherein the detector further comprises a ceramic carrier configured to couple with the photosensor.

8. The detector of claim 6, wherein the shielding mesh comprises a grid.

9. A method for manufacturing a ceramic detectors comprising:
providing a plurality of attached carriers;
at least partially surrounding said plurality of carriers with shielding material;
coupling a plurality of photosensors to said plurality of carriers;
coupling a plurality of shields to said plurality of attached carriers and photosensors to form a plurality of detectors; and
separating the plurality of detectors.

10. The method of claim 9, wherein the separating is snapping apart.

11. The method of claim 8, wherein the separating is cutting apart.

12. The method of claim 8, wherein the coupling is one or more of fastening, adhering, welding, snapping, or fusing.

13. An optical detector assembly method comprising the steps of:
providing a ceramic carrier with embedded shielding material;
coupling a photosensor to the ceramic carrier; and
coupling a shielding cover to the ceramic carrier so as to shield the photosensor from electromagnetic interference.

14. The method of claim 13, wherein the photosensor further comprises a shielding mesh applied to said photosensor.

15. In a patient monitoring system, a ceramic detector comprising:
a sensor;
a ceramic carrier; and
shielding material, the shielding material at least partially surrounding the sensor and configured to reduce the effects of electromagnetic radiation.

16. The ceramic detector of claim 15, wherein the shielding material is chemically applied to the detector.

17. The ceramic detector of claim 15, wherein the shielding material at least partially surrounds the ceramic carrier.

18. The ceramic detector of claim 15, wherein the shielding material is mechanically coupled to the ceramic carrier.

19. The ceramic detector of claim 18, wherein the shielding material includes openings to allow light to reach the sensor.
